(19) United States
(12) Patent Application Publication
(10) Pub. No.: US 2014/0344455 A1
(43) Pub. Date: Nov. 20, 2014

(54) METHOD AND SYSTEM TO MEASURE USER ENGAGEMENT WITH CONTENT THROUGH EVENT TRACKING ON THE CLIENT SIDE

(71) Applicants: Bin Cheng, Eppelheim (DE); Daniele Abbadessa, Heidelberg (DE)

(72) Inventors: Bin Cheng, Eppelheim (DE); Daniele Abbadessa, Heidelberg (DE)

(73) Assignee: NEC EUROPE LTD., Heidelberg (DE)

(21) Appl. No.: 14/366,319

(22) PCT Filed: Mar. 12, 2012
(86) PCT No.: PCT/EP2012/054219

§ 371 Date: Jun. 18, 2014

(30) Foreign Application Priority Data
Dec. 19, 2011 (EP) 11194311.4

(51) Int. Cl. H04L 29/08

(52) U.S. Cl. CPC H04L 67/22
USPC 709/224

(57) ABSTRACT

A method of tracking and analyzing user engagement with content includes receiving content to be displayed on a client device over a network from a publisher, and receiving one or more processing functions on the client device over the network. The processing functions are configured to cause the client device to track and to analyze user events on the client device. The method further includes executing the one or more processing functions on the client device to track and to analyze user events on the client device, and sending results of analyzing user events over the network from the client device to an analytics server. A system for measuring user engagement with content, including an analytics server and a client device configured to track and analyze user events on the client device, and to send the results of analyzing user events to the analytics server is described.

### FIELD OF THE INVENTION

Embodiments of the invention relate tracking and analyzing user engagement with electronic content, such as web content, web applications, e-books, or other electronic media.

### BACKGROUND

As mobile devices such as tablets and smartphones are becoming more and more popular, the way we consume the content from digital publishers is changing. Instead of sitting in front of our PCs, we spend more time reading news and magazines or watching videos on mobile devices as we wait for the train or rest on the couch at home. This change requires digital publishers to target their users across different devices with different properties, such as different window sizes and different interaction interfaces. In addition, the content is presented to the users in a more interactive way so that many user interactions may occur during the process of user reading and watching.

Digital publishers are most interested in how the users interact with the content and how much they are really engaged with the content. The traditional solution to this problem is to use web analytics, such as Google web analytics, which typically tracks only the history of HTTP requests or high level user interactions. However, given the changes discussed above, these existing web analytics technologies are no longer sufficient to measure user engagement in an efficient and precise way. This is because merely opening a page containing content may not be a good indicator that the content has actually been displayed. For example, content may be in a portion of a page that does not fit in the viewable area of a web page, such that the user would need to scroll the page in order to view the content. Even if the content is actually displayed, it might not be viewed by the user. Additionally, conventional tracking and analytics systems may have no way of tracking whether a user seems particularly interested in content—such as content that is highlighted or zoomed-in by the user. All of these issues are even more acute on mobile devices, which use varying display sizes and user interaction technologies (e.g., such as touch screens or gesture-based input).

Thus, conventional web analytics, which operate by capturing the history of HTTP requests, may not be able to sufficiently determine whether or to what degree a user is engaged with particular content. Some existing technologies are able to address these issues to a limited degree by capturing mouse movements or clicks. Such systems generally capture these low level events and send all of them back to the server for further processing. This approach, while it may provide additional information that can be used to improve analytics, has some substantial drawbacks. The large number of events sent back to the server may cause large amounts of computational overhead on the server, and could overwhelm the intermediate network as the number of user increases. These solutions may not be feasible in practice when the data are being uploaded via a wireless network with a limited upload bandwidth, as is often the case with mobile devices. In addition, sending detailed information about the user interactions, such as typed words within the web page, can justifiably lead to serious privacy concerns from users.

### SUMMARY

Based on the above, it is an object of embodiments of the invention to provide a system for tracking and analyzing user engagement with content that provides more precise tracking, while decreasing the computational workload on the analytics server and decreasing the network bandwidth that is used for providing such analytics. This is achieved in accordance with various embodiments of the invention by splitting the analytics task into two parts: a detection component that is performed on the client side for tracking and analyzing user events, and an aggregation component that is executed on the server side, which aggregates statistical results from the analysis that is performed on the client side. Because user events are captured and analyzed on the client side, the system is able to measure user engagement more efficiently without overwhelming the network or the centralized analytics server.

In one embodiment of the present invention, a method of tracking and analyzing user engagement with content is provided. The method includes receiving content to be displayed on a client device over a network from a publisher, and receiving one or more processing functions on the client device over the network. The one or more processing functions are configured to cause the client device to track and to analyze user events on the client device. The method further includes executing the one or more processing functions on the client device to track and to analyze user events on the client device, and sending results of analyzing user events over the network from the client device to an analytics server.

In some embodiments, receiving one or more processing functions on the client device includes receiving one or more processing functions from the analytics server. In some embodiments, the one or more processing functions include event trackers, configured to cause the client device to track user events, and event analyzers, configured to cause the client device to analyze user events that have been tracked.

In some embodiments, the method further includes receiving the results of analyzing events from the client device on the analytics server, aggregating the results on the analytics server, and placing the aggregated results in a database. In some of these embodiments, the method further includes providing access over the network to aggregated results on user engagement with content from the database to the publisher.

In some embodiments, executing the one or more processing functions includes executing an instance of an analytics client on the client device. The analytics client manages the execution of the one or more processing functions to track and to analyze user events on the client device.

In some embodiments, the method further includes registering the publisher on the analytics server to provide the publisher with an identity and with access to one or more processing functions prior to the publisher sending content to the client device. In some embodiments, sending the results of analyzing user events further includes storing the results on the client device if the client device is off-line, and sending the results when the client device is on-line.

In some embodiments, the user events that are tracked and analyzed on the client device include one or more of mouse movement, clicks, scroll events, magnify events, and select events. In some embodiments, the content includes a web page or an e-book.

In some embodiments of the invention, system for tracking and analyzing user engagement with content is provided. The system includes an analytics server configured to receive over a network and aggregate information on user engagement with content, and to provide access to such aggregated information to publishers. The system also includes a client device configured to receive content to be displayed on the client device over the network. The client device is further configured to receive one or more processing functions over the network. The one or more processing functions are configured to cause the client device to track and to analyze user events on the client device. The client device is also configured to execute the one or more processing functions on the client device to track and to analyze user events on the client device, and send results of analyzing user events over the network to the analytics server.

In some embodiments, the analytics server further includes a database of processing functions, and the client device is further configured to receive the one or more processing functions from the analytics server. In some embodiments, the one or more processing functions include event trackers, configured to cause the client device to track user events, and event analyzers, configured to cause the client device to analyze user events that have been tracked.

In some embodiments, the analytics server further includes a database for storing the aggregated information and for providing access to the aggregated information to publishers. In some embodiments, the client device further includes storage that stores results of analyzing user events when the client device is off-line.

In some embodiments, the user events that are tracked and analyzed on the client device include one or more of mouse movement, clicks, scroll events, magnify events, and select events. In some embodiments, the content includes a web page or an e-book. In some embodiments, the client device includes a personal computer, a smart phone, a tablet, an e-book reader, or a mobile device.

In some embodiments, a client device for displaying content is provided. The client device includes a browser that receives content over a network from a publisher and displays the content. The client device also includes an analytics client that receives one or more processing functions over the network. The one or more processing functions are configured to cause the client device to track and to analyze user events on the client device. The analytics client further executes the one or more processing functions on the client device to track and to analyze user events on the client device, and sends results of analyzing user events over the network from the client device to an analytics server. In some embodiments, the client device further includes storage that stores results of analyzing user events when the client device is off-line.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows the nature of a difficulty with conventional web analytics techniques;

FIG. 2 illustrates a further difficulty with conventional web analytics techniques;

FIG. 3 shows the high-level structure of a conventional web analytics system;

FIG. 4 shows a structure for a content or web-analytics system in accordance with an embodiment of the invention;

FIG. 5 shows a more detailed overview of a system for tracking and analyzing user engagement with content in accordance with an embodiment of the invention;

FIG. 6 shows a method for tracking and analyzing user engagement with content in accordance with an embodiment of the invention;

FIG. 7 shows the structure of an analytics client in accordance with an embodiment of the invention; and

FIG. 8 shows a method for operating an analytics client in accordance with an embodiment of the invention.

### DESCRIPTION

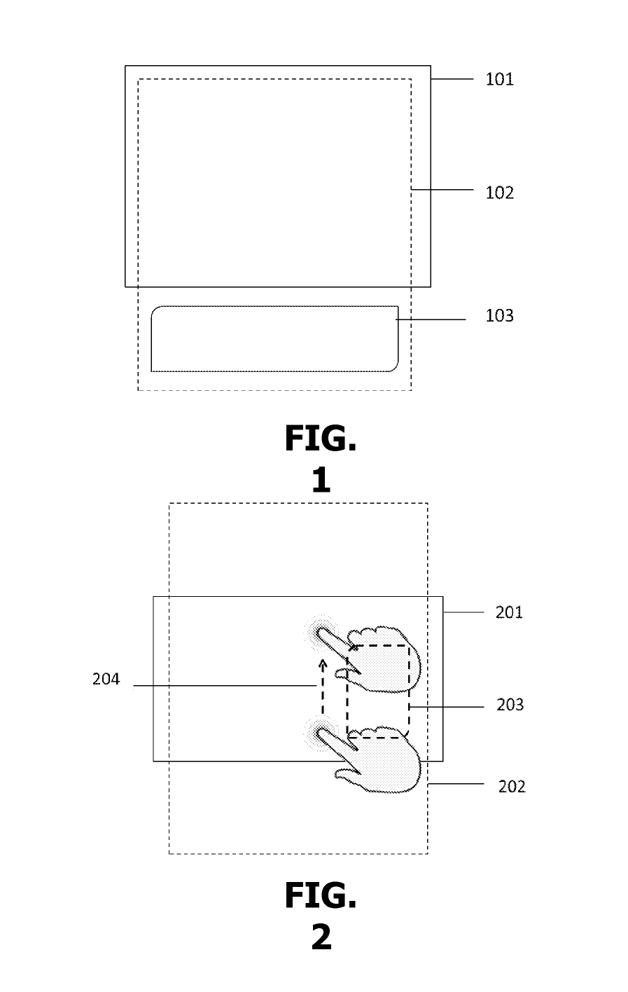

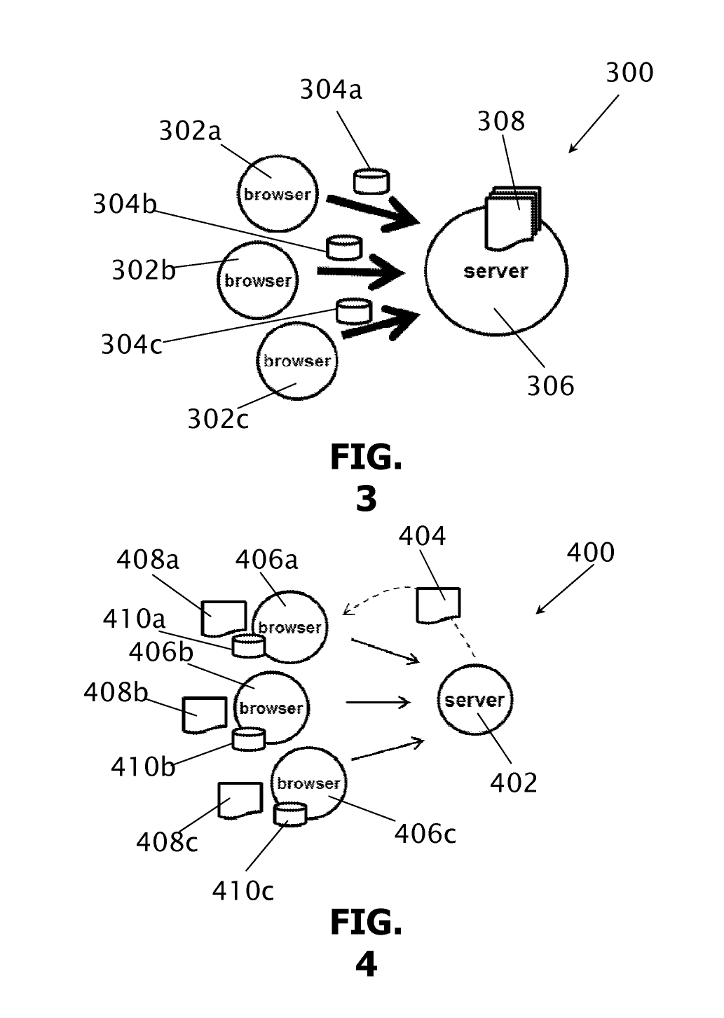

Referring to FIGS. 1 and 2, the nature of some of the difficulties with conventional web analytics technologies are described. As was noted above, conventional web analytics, which are typically based on HTTP requests or high-level user interactions are unable to measure user engagement with sufficient precision, particularly when used with mobile devices or other devices that use displays or user interaction technologies that are different from the personal computer-based display and interaction technologies for which such conventional analytics were designed.

For example, simply because a web page or other content is opened does not mean that it is actually displayed. Using cookie technology, a conventional tracking system can easily find out which web pages the user is visiting (or has already visited) from the history of HTTP requests that are generated by the user clicks. But opening a web page does not necessarily mean the whole page is displayed on the screen. In some cases, the user does not see some of the elements within the opened web page. This is quite common in the environment of mobile devices, since mobile devices often have a small screen size.

For example, as shown in FIG. 1, a web page 102 is open on the screen 106 of a tablet, with an advertisement 103 at the bottom of the page 102. However, from the user's perspective the advertisement 103 will not been seen by the user if the user does not scroll down the page 102, since the bottom portion of the page 102 is not in the visible area of the user's screen 101. If the advertiser is charged using the model of CPM (cost per impression), this could lead to a complete miscalculation. This kind of miscalculation can also happen, for example, when the user is reading an HTML5-based magazine where each page contains several sections. If the user does not scroll further, only the first section is displayed to the user in each page.

As a further example of the difficulties with conventional web analytics, just because an element in a web page is displayed does not necessarily mean that it is viewed. In some cases, the elements within the web page are not able to capture any user impression, even if they are actually displayed on the screen. For example, as shown in FIG. 2, an advertisement 203 on the right side of a web page 202 that is being viewed on a touch screen 201 of a tablet is almost hidden by the user's hand 204, as the user uses a touch gesture to scroll up the web page 202. Therefore, the advertisement 203 does not catch any user impression at all, even though it is both opened and displayed. Moreover, this is just one of the examples where the user is not engaged with the displayed content of the web page. There are many other examples having a similar effect. For example, showing a video which is not really clicked by the user, or showing a web page which is zoomed out initially because of its improper page size.

Even if an element is viewed, conventional tracking and analytics systems have no good way of assessing a degree of user interest in the element. In some case, selected text or keywords within the page may be highlighted by the user, for example as magnified elements or selected text lines on the screen. In terms of user impression, this may indicate that the user is highly interested in this part of content.

All of these examples indicate that capturing the history of HTTP requests may not be enough to determine whether or how much the user is really engaged with the content that a digital publisher pushes to the user. To be more precise, a finer level of analytics is needed for digital publishers to better capture the user engagement with their media content. As discussed above, some conventional tracking and analytics systems may track low-level activity, such as mouse movements and clicks, and send such information to a server for processing and analysis. Tracking such activity on a low level, and sending it to a central server can cause increased network traffic as the number of users increases, lead to legitimate privacy concerns, and may not even be feasible on devices, such as many mobile devices, which have limited upload bandwidth.

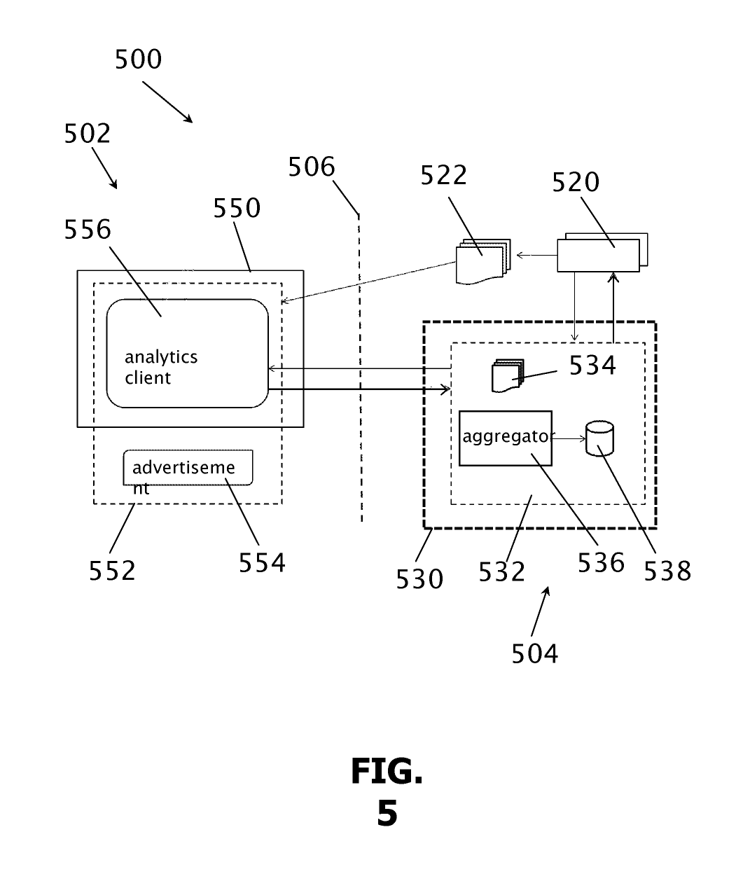

This conventional approach is illustrated in FIG. 3. In FIG. 3, the system 300 includes numerous browsers 302a, 302b, and 302c, each of which tracks events associated with the web pages within the browser. Each of the browsers 302a, 302b, and 302c sends its collected event data 304a, 304b, 304c back to a server 306, which processes the event data 302a, 302b, and 302c using processing functions 308 to provide web analytics information.

FIG. 4 shows an analytics system 400 in accordance with an embodiment of the invention. Instead of sending all raw event data from the clients to the server without any processing, the processing functions are moved from the server to the clients, where the events are generated. Thus, in the system 400 of FIG. 4, the server 402 transfers processing functions 404 to the browsers 406a, 406b, and 406c. The browsers 406a, 406b, and 406c each collect event data 410a, 410b, 410c, and process the event data using processing functions 408a, 408b, and 408c, which were received from the server 402. The processing functions 408a, 408b, and 408c analyze the event data 410a, 410b, 410c within the browsers 406a, 406b, 406c on the user side in a secure and flexible way. The analysis results are then sent back to the server 402 to generate statistical results on user engagement.

This can greatly reduce the bandwidth usage of network and dramatically offload the central server in terms of computation and data storage. Since the server does not need to save the detailed events, the privacy concerns associated with sending detailed event information to a central server are also mitigated.

More specifically, various embodiments of the invention split the analytics task into two parts:

a detection component that is shipped to the client side for pre-analysis, and

an aggregation component that is executed on the server side.

Because user events are captured and analyzed on the client side, the system is able to measure user engagement more efficiently without overwhelming the network or the centralized analytics server. In some embodiments, features of HTML5 not only enable the system to capture as many events as possible, but also allow some processing to be done on the client side without the installation of any browser plugins or extensions. For example, HTML5 can support web worker and local storage, which provides the capability of computation and storage within the browser environment respectively. Of course, in some embodiments, other technologies may be used for capturing and processing events at the client side. Some of these technologies may involve use of a browser plugin. In some embodiments, user events are captures and analyzed in environments other than a web browser. For example, similar results could be also obtained by embedding such detection and analysis components into e-reader applications.

Additionally, by placing a detection component on the client side, which performs detection and processing of the events, information on user engagement may also be captured when the user is not connected to a network. The aggregate results can then be sent to the server when the user is connected to a network, thus enabling the publisher to obtain the aggregated results.

It should be noted that various embodiment of the invention measure user engagement through client-side low level event tracking and analysis. While the examples focus on measuring user engagement on webpages, it will be understood that the same concepts could be applied to e-publishing delivered in HTML or other formats. In addition the concepts could be applied in e-reader applications. In this case, the detection component would be specific to the e-reader and may be embedded into the application.

Referring now to FIG. 5, a more detailed overview of the system is described. The system 500 includes a client 502 connected to a server side 504 over a network 506. The server side 504 includes publishers 520, and an analytics service provider 530, which operates an analytics server 532, including a code database 534 of pre-defined trackers and analyzers (i.e., the “processing functions” of FIG. 4), an aggregator 536, which aggregates analytics results from all users/client devices and calculates statistical results, and a results database 538, which stores the aggregated statistical results and makes results for the publishers' web sites available to the publishers 520 who operate the web sites.

Each of the publishers 520 manages its own web site, which usually includes a set of web pages 522. To enable user engagement analytics of their own web pages, the publishers 520 embed code, such as JavaScript code or other code that can be interpreted or executed on the client side into the web pages 522. The publishers 520 also specify what kind of event trackers and/or event analyzers are to be used on their web sites. The publishers can, for example, choose pre-defined trackers and analyzers for use on their web sites. Such pre-defined trackers and analyzers can be implemented in some embodiments by the analytics service provider, and be stored in the code database 534. The analytics service provider 530 is responsible for the management of all analytics servers 532, which receive the results from all the users/client devices and provide statistical reports to the publishers 520 after aggregating the received information from the client devices.

The client 502, which may be a personal computer or mobile device, such as a smart phone, tablet, or e-book reader, includes generally a browser 550, which displays a view of content, such as web page 552 (which may be one of the web pages 522, provided by a publisher 520), including content such as an advertisement 554, which may or may not be displayed in the browser 550. The browser 550 also executes (either natively, using JavaScript, HTML5, etc., or through a plug-in) at least one instance of an analytics client 556, which is embedded in the web page 552, and tracks and analyzes events on the client 502 to measure user engagement. Generally, on the client 502, a user can read the content from a publisher 520 through an Internet browser 550 or other native application with an embedded browser on PCs, tablets, or smart phones. When the user is reading the content, he will interact with the content in different ways, which will be tracked and analyzed by the analytics client 556, before sending analyzed results to an aggregator 536 an analytics server 532, which will aggregate the results and provide the results to the publishers 520.

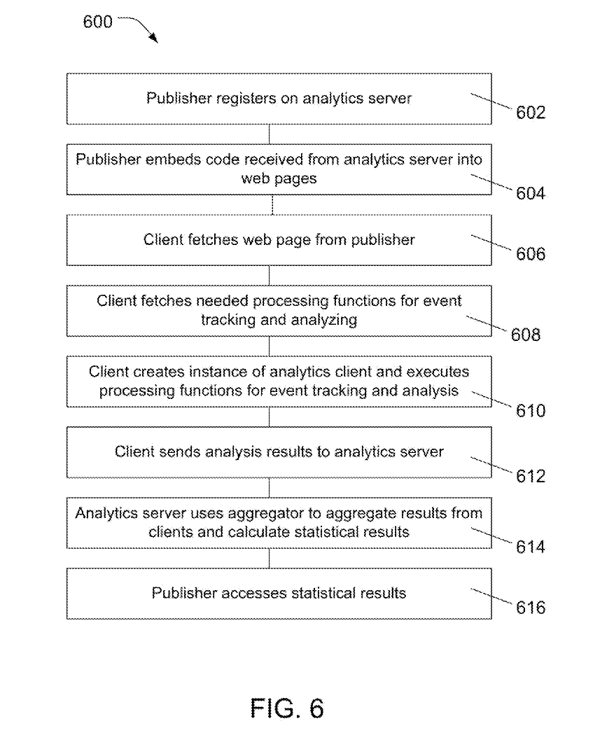

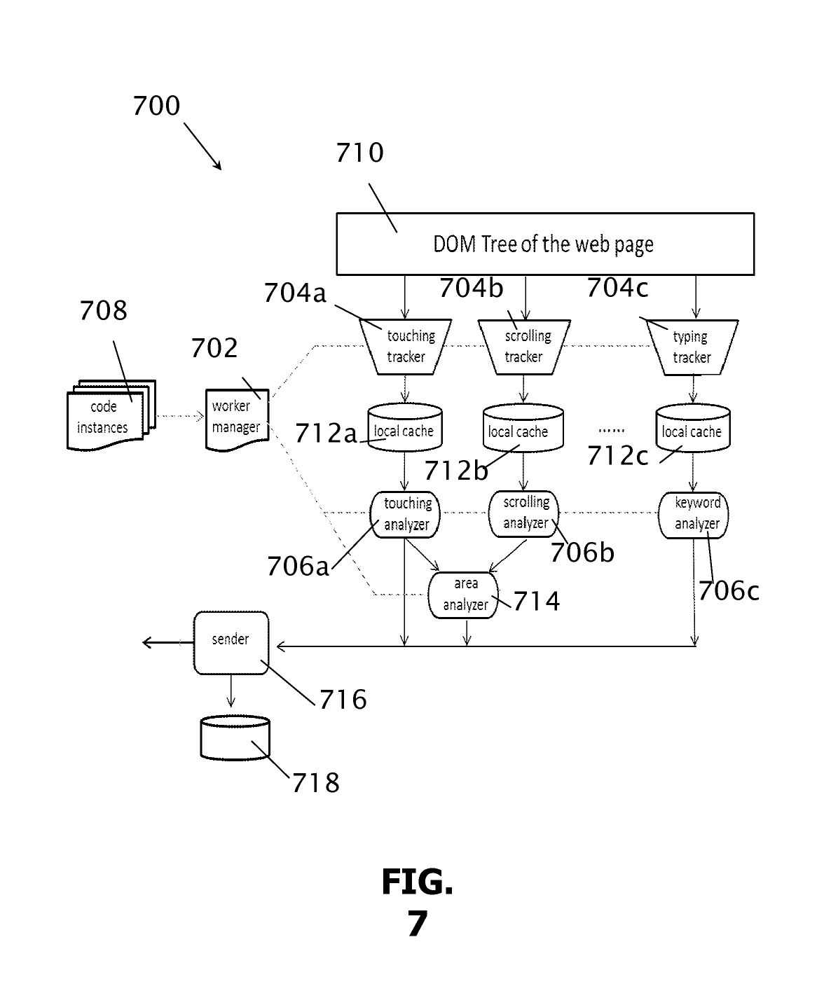

FIG. 6 illustrates an overall method 600 for performing client-side detection and analysis of user engagement and sending the results to a server for reporting to content publishers, in accordance with an illustrative embodiment of the invention. At 602, the publisher registers on the analytics server and gets an identity for his own web site. The publisher then specifies or chooses the event trackers and event analyzers that will be used to track and measure the engagement of users on the publisher's web pages. In some embodiments, the publisher may receive a piece of code, such as JavaScript code, which contains his identity (PID) and a link to tracking and analysis code (i.e., processing functions) stored in a database on the analytics server. At 604, the publisher embeds the code (e.g., the JavaScript code) returned from the analytics server into the web pages in which user engagement is to be measured.

At 606, the client fetches the web page or other content that contains the embedded code (i.e., the PID and links to the tracking and analysis code). At 608, when the browser is loading the fetched web page, a request is sent to the analytics server to fetch the needed processing functions, including the tracking and analysis code. The analytics server customizes this code and sends it to the browser on the client side. For example, if JavaScript is being used, a request is sent to the analytics server to fetch the JavaScript code for tracking and analyzing events. The analytics server generates a file containing this JavaScript code according to the publisher id (PID) and pre-defined specification rules for the publisher. Finally, the analytics server will send this customized JavaScript code to the browser on the client side. It will be understood that the processing functions may be received by the client in other ways in some embodiments. For example, in some embodiments, the code for the processing functions could be directly embedded in the content, and downloaded along with the content from the publisher. In other embodiments, the content may include links to the processing functions that are downloaded from the analytics server, from the publisher, or from other sources, such as third-party providers of event trackers and/or event analyzers.

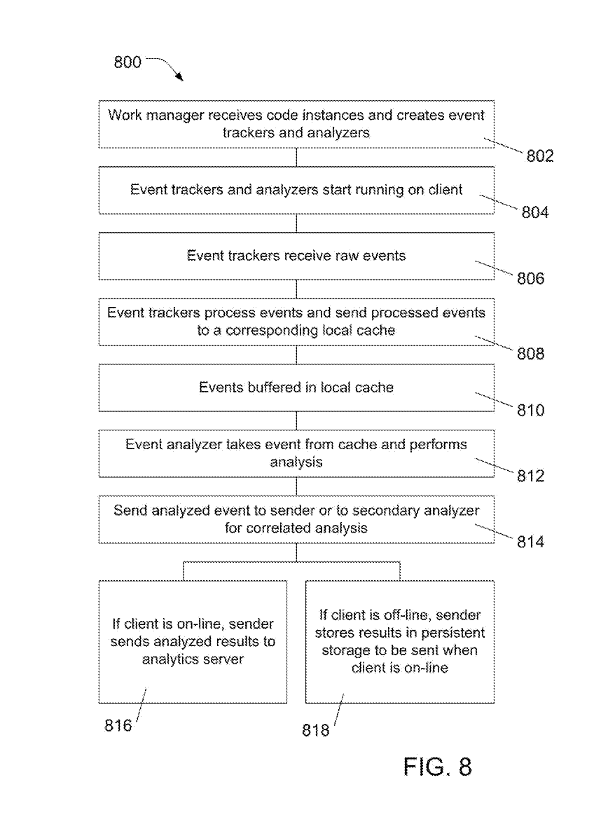

At 610, after the browser receives the code file, it can create an instance of an analytics client running inside the browser on the client device. The analytics client executes the code to track low level events and to analyze them to measure user engagement on the current web page. The processing functions executed in the analytics client can track different kinds of events, such as mouse movement, clicks, scroll, magnify, and select, and analyze these events. Which events are tracked and what analysis is performed on the client side are determined by the publisher. More detail on the operation of the analytics client is provided below, with reference to FIGS. 7 and 8.

At 612, before the web page is closed, or when some analysis results have been derived from the collected event streams, the browser sends the analysis results back to the analytics server. At 614, the analytics server uses the aggregator to aggregate the results from all the users/clients and calculates the statistical results. The aggregated statistical results are stored in a database on the analytics server, and can be updated and presented to the publisher in a real-time manner.

At 616, the publisher can check the statistical results through, e.g., a web-based management portal provided by the analytics server. The results can, for example, show how many users view a particular advertisement within the web page, what percentage of the users interact with the content in some particular area of a page, how much time the user displays a particular item of video content within the web page, and so on.

FIG. 7 gives more detail on the framework of the analytics client on the client side. As shown in FIG. 7, the analytics client 700 includes a work manager 702 that creates multiple event trackers 704a-c and multiple event analyzers 706a-c (as well as secondary analyzers 714) based on code instances 708 (i.e., code for processing functions such as trackers and analyzers) received from the analytics server (not shown). The event trackers receive raw events through the document-object model (DOM) tree of the web page 710 that is being displayed in the browser (not shown). Each event tracker 704a-c tracks one type of event and has at least one corresponding event analyzer 706a-c to process the event stream generated by the tracker 704a-c. In some embodiments, local caches 712a-c can be used between the event trackers 704a-c and the event analyzers 706a-c, to temporarily buffer the events. As the events are generated, multiple event trackers 704a-c and event analyzers 706a-c may be working in parallel.

In addition to the event analyzers 706a-c that correspond to the event trackers 704a-c, some embodiments may include one or more secondary analyzers 714, which take their inputs either from event analyzers or from other secondary analyzers. The more detailed steps are the following. The analytics client 700 also includes a sender 716, which sends the results of the analysis to the analytics server (not shown), and/or may store the results of analysis on the client in persistent storage 718, e.g., if the client is temporarily off-line, so the results can be sent to the analytics server once the client is online.

FIG. 8 shows a method 800 for operating the analytics client. At 802, the work manager receives code instances (e.g., JavaScript code) from the analytics server as input, and creates various event trackers and event analyzers to run in the browser environment. Any event tracker or event analyzer is a worker instance, which has particular inputs that are predefined by a publisher, and a limited environment for computation that prevents them from changing anything in the system except the received input data. The event trackers and analyzers can be implemented by the web page publisher or by the analytics service provider who is responsible for the analytics server. The event trackers could be specifically implemented by a publisher or developed based on specifications provided by a publisher. Alternatively, “generic” event trackers could be used. A subset of such event trackers may be selected based on the specific needs of the publisher. Finally, a further level of standardization could be achieved in some embodiments by using “generic” event trackers that can be customized to accomplish specific tracking activities by providing specific configuration parameters.

At 804, the event trackers and analyzers (both event analyzers and secondary analyzers) start running, to track user events and analyze the events.

At 806, the event trackers receive raw events from the current DOM tree after the related event listeners have been set up by the work manager according to the publisher specification. It will be understood that raw events may be received from other sources, depending on the environment in which the analytics client is running. At 808, each event tracker does its own processing, such as event filtering or event information extraction, and then sends the post-processed events into the corresponding local cache.

At 810, the events are temporarily saved in the local cache, which acts as an event queue. Whenever a new event comes into the queue, at 812, the corresponding event analyzer will be triggered to execute. For example, a touch event on a smartphone will first be processed by the touching event tracker and then put into a dedicated cache. Placement of the event in the cache will trigger the touching event analyzer to perform further processing to detect the content area displayed to the user according to the event queue which keeps all touch events occurring in the current page.

At 814, after the corresponding event analyzer finishes its analysis, it will send the analysis result to the sender, or provide the result to a secondary analyzer for further correlated analysis. As explained above, some analyzers (referred to as secondary analyzers) can receive results from other analyzers (both from event analyzers and other secondary analyzers) and do correlated analysis, such as area detection. For example, in the illustrative embodiment shown in FIG. 7, to detect the precise area where the user is viewing the content, the area analyzer 714 processes information from both the touching analyzer 706a and the scrolling analyzer 706b.

Finally, at 816, the sender will send the results to the remote analytics server as soon as it receives the result from any analyzer. Alternatively, if the client is temporarily offline, at 818, the sender can save the result into persistent storage associated with the current domain. Once the client is again online, the saved result will be sent back to the server.

As described above, embodiments of the invention provide for measuring user engagement with digital content by splitting the analytics into two parts. One part is executed within the browser on the client side, to capture and analyze individual behavior. The other part runs on the server side, to aggregate the statistical result across all users. By moving much of the analysis to the client side, the computation load on the analytics server and the network bandwidth usage can be greatly reduced.

Additionally, the split of the analytics into two parts permits information about user engagement with the content to be captured when the client device is not connected to a network. Capture, processing and analysis of user events are performed locally on the client. Processed results are transferred to the server when the client is connected to a network.

To achieve this client-based event capture and analysis, a work manager is launched within the browser on the client to create multiple event trackers and analyzers to process different kinds of events according to the specification provided by the publisher. Thus, the method is able to dynamically load customized event trackers and analyzers to specifically track and measure whichever aspects of user engagement with the content the publishers would like to measure. This improves performance, since only the events that are needed to achieve the level of detail requested by specific publishers are captured and analyzed on the client.

For each type of event, there is a dedicated tracker to extract the related event information, and at least one analyzer to analyze the user behavior for the purpose of measuring user engagement associated with the elements within the current web page or other content. Each tracker and each analyzer is loaded dynamically, and handles its processing and computation within a constrained working environment. A local cache is set up to buffer the output of each event tracker, and to cache the extracted event stream for the corresponding analyzer to do perform further analysis. The behavior of each tracker and each analyzer can be defined by the publisher, or pre-implemented by the analytics service provider. The event analyzers and trackers can also be run in parallel, and the outputs of the analyzers can be combined as the inputs of another (secondary) analyzer, to perform correlated analysis.

The analysis result can be sent to the centralized analytics server over a network in a real-time manner, so that the up-to-date statistical results provided by the analytics server can be updated efficiently and quickly. The analytics server can provide its statistical results to the publishers of content in such a way that low level event streams are never directly sent over the network to the analytics server, reducing the needed bandwidth, and reducing some user privacy concerns.

Thus, in summary, embodiments of the invention provide for capturing detailed information about user behavior at the low level, and analyzing user behavior on the client side. This enables user engagement with the content to be measured at different levels, according to the needs of the publisher. Handling at least a portion of the analysis on the client side also offloads work from the centralized analytics server, and saves bandwidth usage that would otherwise be needed to send event streams to the analytics server for analysis. By doing tracking and analysis on the client side, off-line tracking (i.e., tracking while the client is not connected to the network) also can be done, and the results of the tracking and analysis can be sent when the client is on-line. Additionally, embodiments of the invention provide flexibility and modularity in the event capturing and analyzing components, as well as the ability to provide aggregated statistical results from the analytics server in real time.

Advantageously, embodiments of the invention provide content publishers with improved precision in their measurements of user engagement because of the increased amounts of user behavior information that can be used as the inputs to the analysis on the client side. Additionally, content publishers have flexibility to customize the information that they wish to capture about their users behavior, since the system allows publishers to define their own analyzers. By offloading processing for substantial portions of the analysis to the client side, the efficiency of an analytics service provider tracking user behavior can be improved. The statistical results produced by the system can be used to guide content publishers to optimize the page layout of their content.

To implement a system in accordance with some embodiments of the invention, the client side may need to support a technology that permits code to be executed within a browser or other content-viewer environment. For example, technologies such as HTML5 and/or Javascript can be used for this purpose in current systems. Such technologies are becoming standard in browsers and content viewers, and the main browsers on both PCs and mobile devices already support HTML5. Thus, it is expected that execution of event trackers and analyzers on the client side will not be a problem.

For some devices or applications, such as e-reader applications, this ability to execute code in the context of a client-side content viewer may not be as standard as in web browsers. In some embodiments, such capabilities may be embedded in the content viewing applications, which may require customization and agreement with the content viewing software provider.

Additionally, systems that track user engagement with content may raise some privacy concerns from the users. This is a common issue for any such technology. Advantageously, in embodiments of the invention, the privacy problems may less severe, since most or all of the tracking is done on the client, and the system does not send the tracked raw data to the server.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of tracking and analyzing user engagement with content, the method comprising:
receiving content to be displayed on a client device over a network from a publisher;
receiving one or more processing functions on the client device over the network, the one or more processing functions configured to cause the client device to track and to analyze user events on the client device;
executing the one or more processing functions on the client device to track and to analyze user events on the client device; and
sending results of analyzing user events over the network from the client device to an analytics server.

2. The method of claim 1, wherein receiving one or more processing functions on the client device comprises receiving one or more processing functions from the analytics server.

3. The method of claim 1, wherein the one or more processing functions comprise event trackers, configured to cause the client device to track user events, and event analyzers, configured to cause the client device to analyze user events that have been tracked.

4. The method of claim 1, further comprising receiving the results of analyzing events from the client device on the analytics server, aggregating the results on the analytics server, and placing the aggregated results in a database.

5. The method of claim 4, further comprising providing access over the network to aggregated results on user engagement with content from the database to the publisher.

6. The method of claim 1, wherein executing the one or more processing functions comprises executing an instance of an analytics client on the client device, the analytics client managing the execution of the one or more processing functions to track and to analyze user events on the client device.

7. The method of claim 1, further comprising registering the publisher on the analytics server to provide the publisher with an identity and with access to one or more processing functions prior to the publisher sending content to the client device.

8. The method of claim 1, wherein sending the results of analyzing user events further comprises storing the results on the client device if the client device is off-line, and sending the results when the client device is on-line.

9. The method of claim 1, wherein the user events that are tracked and analyzed on the client device comprise one or more of mouse movement, clicks, scroll events, magnify events, and select events.

10. The method of claim 1, wherein the content comprises a web page or an e-book.

11. A system for tracking and analyzing user engagement with content, the system comprising:
an analytics server, the analytics server configured to receive over a network and aggregate information on user engagement with content, and to provide access to such aggregated information to publishers; and
a client device, the client device configured to receive content to be displayed on the client device over the network, receive one or more processing functions over the network, the one or more processing functions configured to cause the client device to track and to analyze user events on the client device, execute the one or more processing functions on the client device to track and to analyze user events on the client device, and send results of analyzing user events over the network to the analytics server.

12. The system of claim 11, wherein the analytics server further comprises a database of processing functions, and wherein the client device is further configured to receive the one or more processing functions from the analytics server.

13. The system of claim 11, wherein the one or more processing functions comprise event trackers, configured to cause the client device to track user events, and event analyzers, configured to cause the client device to analyze user events that have been tracked.

14. The system of claim 11, wherein the analytics server further comprises a database for storing the aggregated information and for providing access to the aggregated information to publishers.

15. The system of claim 11, wherein the client device further comprises storage that stores results of analyzing user events when the client device is off-line.

16. The system of claim 11, wherein the user events that are tracked and analyzed on the client device comprise one or more of mouse movement, clicks, scroll events, magnify events, and select events.

17. The system of claim 11, wherein the content comprises a web page or an e-book.

18. The system of claim 11, wherein the client device comprises a personal computer, a smart phone, a tablet, an e-book reader, or a mobile device.

19. A client device for displaying content, the client device comprising:
a browser that receives content over a network from a publisher and displays the content; and
an analytics client that receives one or more processing functions over the network, the one or more processing functions configured to cause the client device to track and to analyze user events on the client device, executes the one or more processing functions on the client device to track and to analyze user events on the client device, and sends results of analyzing user events over the network from the client device to an analytics server.

20. The client device of claim 19, further comprising storage that stores results of analyzing user events when the client device is off-line.
